(19) United States
(12) Patent Application Publication
(10) Pub. No.: US 2019/0271379 A1
(43) Pub. Date: Sep. 5, 2019

(54) PASSIVE PRELOAD CONTROL FOR A BALL-TYPE CONTINUOUSLY VARIABLE PLANETARY TRANSMISSION

(71) Applicant: Dana Limited, Maumee, OH (US)

(72) Inventors: Joseph J. Horak, Austin, TX (US); Benjamin L. Powell, Austin, TX (US)

(21) Appl. No.: 16/275,840

(22) Filed: Feb. 14, 2019

Related U.S. Application Data
(60) Provisional application No. 62/636,911, filed on Mar. 1, 2018.

(51) Int. Cl. F16H 15/50; F16C 25/08

(52) U.S. Cl. CPC F16H 15/503; F16C 25/083

(57) ABSTRACT

Provided herein is a continuously variable transmission (CVT) having a plurality of balls, each ball having a tiltable axis of rotation, each ball in contact with a first traction ring and a second traction ring, the CVT including: a main shaft aligned along a longitudinal axis of the CVT, the main shaft positioned radially inward of the balls, the first traction ring and the second traction ring; a cam driver operably coupled to the first traction ring; an axial thrust bearing operably coupled to the cam driver and the main shaft; an inner race member coupled to the axial thrust bearing and the cam driver; an outer race member coupled to the axial thrust bearing and the main shaft; and a passive preload ring coupled to the inner race member and the cam driver.

### RELATED APPLICATION

This applications claims benefit of and priority to U.S. Provisional Application Ser. No. 62/636,991 filed on Mar. 1, 2018 which is incorporated by reference in its entirety herein.

### BACKGROUND

Automatic and manual transmissions are commonly used on automobiles. Such transmissions have become more and more complicated since the engine speed has to be adjusted to limit fuel consumption and the emissions of the vehicle. A vehicle having a driveline including a tilting ball variator allows an operator of the vehicle or a control system of the vehicle to vary a drive ratio in a stepless manner. A variator is an element of a Continuously Variable Transmission (CVT) or an Infinitely Variable Transmission (IVT). Transmissions that use a variator can decrease the transmission's gear ratio as engine speed increases. This keeps the engine within its optimal efficiency while gaining ground speed, or trading speed for torque during hill climbing, for example. Efficiency in this case can be fuel efficiency, decreasing fuel consumption and emissions output, or power efficiency, allowing the engine to produce its maximum power over a wide range of speeds. That is, the variator keeps the engine turning at constant RPMs over a wide range of vehicle speeds.

### SUMMARY

Provided herein is a continuously variable transmission (CVT) having a plurality of balls, each ball having a tiltable axis of rotation, each ball in contact with a first traction ring and a second traction ring, the CVT including: a main shaft aligned along a longitudinal axis of the CVT, the main shaft positioned radially inward of the balls, the first traction ring and the second traction ring; a cam driver operably coupled to the first traction ring; an axial thrust bearing operably coupled to the cam driver and the main shaft; an inner race member coupled to the axial thrust bearing and the cam driver; an outer race member coupled to the axial thrust bearing and the main shaft; and a passive preload ring coupled to the inner race member and the cam driver.

In some embodiments of the CVT, the inner race member is an annular ring having an inner bore and an outer periphery, and the passive preload ring is located between the inner bore and the outer periphery.

In some embodiments of the CVT, the inner race member further includes a raceway located between the inner bore and the outer periphery, the raceway is configured to receive the axial thrust bearing.

In some embodiments of the CVT, the passive preload ring is arranged in proximity to the raceway.

In some embodiments of the CVT, the passive preload ring has a larger thermal coefficient of expansion than the inner race member.

Provided herein is a passive preload device for a ball-type continuously variable planetary, the passive preload device including: an axial thrust bearing; an inner race member coupled to the axial thrust bearing; a passive preload ring coupled to the inner race member; and an outer race member coupled to the axial thrust bearing, wherein the passive preload ring has a larger thermal expansion coefficient than the inner race member.

In some embodiments of the passive preload device, the passive preload ring is composed of a polymer material.

Provided herein is an idler assembly for a ball-type continuously variable planetary, the passive preload device including: a first idler ring; a second idler ring; an idler race coupled to the first idler ring and positioned radially inward of the first idler ring and the second idler ring; an idler bearing coupled to the second idler ring and the idler race; a retaining clip coupled to the idler race and the first idler ring; and a passive preload ring coupled to the retaining clip and the first idler ring, wherein the passive preload ring has a larger thermal expansion coefficient than the first idler ring.

In some embodiments of the idler assembly, the passive preload ring is composed of a polymer material.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a cross-sectional plan view of a ball-type continuously variable transmission depicting a passive preload control device.

FIG. 5 is an isometric cross-sectional view of certain components of the ball-type continuously variable transmission of FIG. 4.

FIG. 6 is a cross-section view of an idler assembly having a passive preload control device used in the ball-type continuously variable transmission of FIG. 4.

### DETAILED DESCRIPTION OF THE PREFERRED EMBODIMENTS

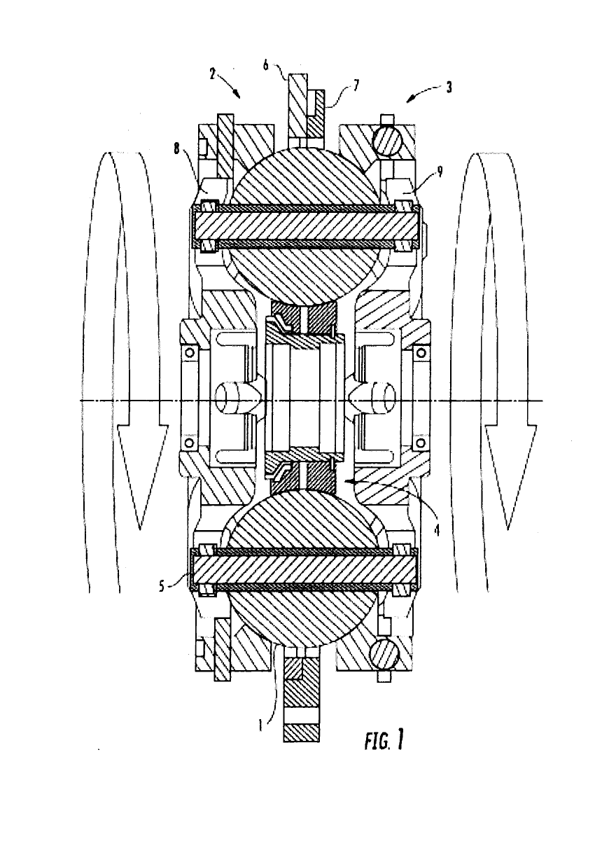

Provided herein are configurations of CVTs based on ball-type variators, also known as CVP, for continuously variable planetary. Basic concepts of a ball-type Continuously Variable Transmissions are described in U.S. Pat. No. 8,469,856 and U.S. Pat. No. 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls 1, as a first traction ring 2 and a second traction ring 3, and an idler (sun) assembly 4 as shown on FIG. 1. The balls 1 are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first carrier member and the second carrier member to impart a tilting of the axles 5 and thereby adjusts the speed ratio of the variator. Other types of ball CVTs also exist, like the one produced by Milner, but are slightly different.

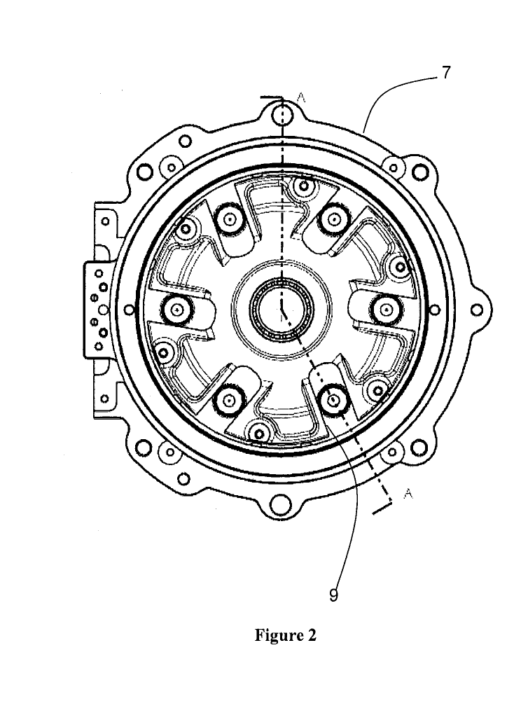

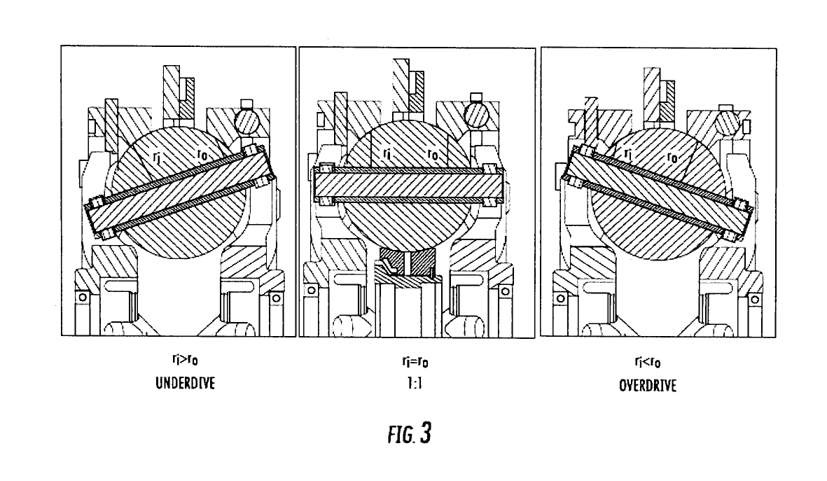

The working principle of such a CVP of FIG. 1 is shown on FIG. 2. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that is capable of being adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, lubricant sleeve assembly 22A and lubricant sleeve assembly 22B) will be referred to collectively by a single label (for example, lubricant sleeve assembly 22).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. In some embodiments, the traction coefficient is a design parameter in the range of 0.3 to 0.6. Typically, friction drives generally relate to transferring power between two elements by frictional forces between the elements. For the purposes of this disclosure, it should be understood that the CVTs described here may operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

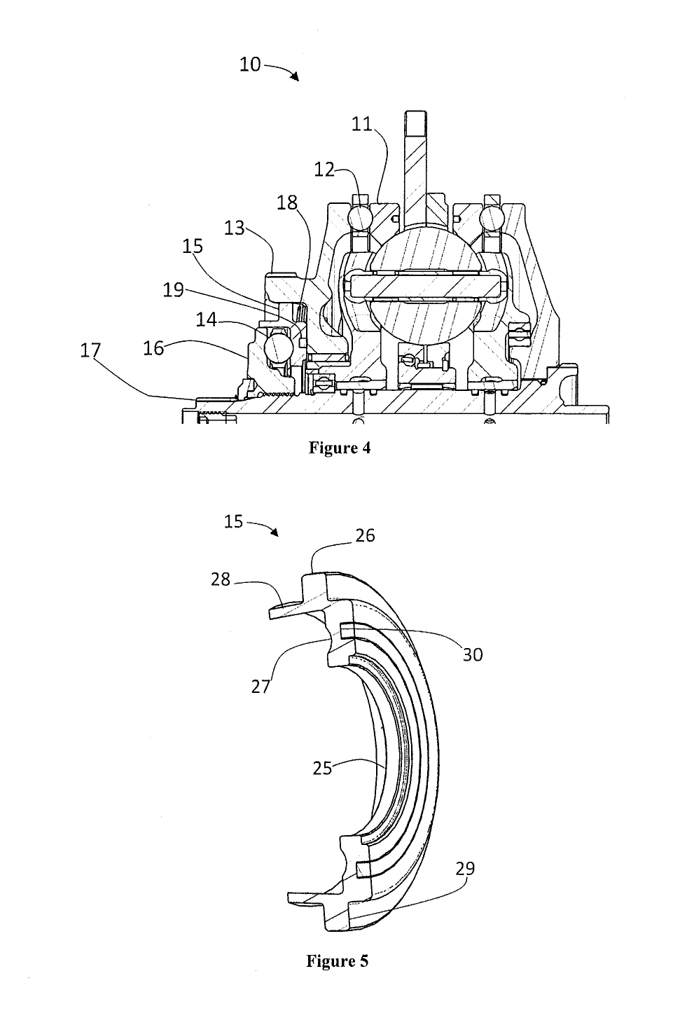

Referring now to FIGS. 4-6, traction fluids known in the field exhibit a change in the traction coefficient with respect to temperature. For example, the traction coefficient decreases as temperature of the fluid increases. The decrease in traction coefficient corresponds to a decrease in the amount of torque capacity the variator can transfer before slip at the contact surfaces. Axially preloading the traction surfaces is one way of maintaining the torque capacity across a wide range of temperatures, but that is at the expense of efficiency. The axial preload inversely effects the efficiency. For example, as the axial preload is increase, the efficiency decreases, and vice versa. It is desirable to have a minimal preload that satisfies all operating conditions of the variator. Since CVTs experience a wide range of temperatures during operation, there is a need to implement a device to change the axial preload as a function of temperature.

Referring now to FIG. 4, in some embodiments, a continuously variable planetary (CVP) 10 is similar to the variator described in reference to FIGS. 1-3. For description purposes, only the differences between the CVP 10 and the variator of FIGS. 1-3 will be discussed.

In some embodiments, the CVP 10 includes a first traction ring 11 coupled to an axial force generator 12. The axial force generator 12 is coupled to a cam driver 13. In some embodiments, the cam driver 13 is configured to transfer a rotation power in or out of the CVP 10.

In some embodiments, the CVP 10 includes an axial thrust bearing 14 having an inner race member 15 and an outer race member 16.

In some embodiments, the outer race member 16 is adapted to couple to a main shaft 17 of the CVP 10. In some embodiments, the outer race member 16 attaches to the main shaft 17 through threads.

In some embodiments, the CVP 10 includes a preload spring 18 coupled to the inner race member 15 and the cam driver 13.

In some embodiments, the CVP 10 includes a passive preload ring 19 coupled to the inner race member 15 and the cam driver 13.

Referring now to FIG. 5, in some embodiments, the inner race member 15 is a generally annular ring having an inner bore 25 and an outer periphery 26. The inner race member 15 includes a raceway 27 configured to receive the axial thrust bearing 14.

In some embodiments, the inner race member 15 includes a piloting extension 28 located between the raceway 27 and the outer periphery 26. In some embodiments, the piloting extension 28 extends axially away from the raceway 27 and is configured to radially surround the outer race member 16.

In some embodiments, the inner race member 15 includes a reaction surface 29 arranged between the piloting extension 28 and the outer periphery 26. In some embodiments, the reaction surface 29 is adapted to couple to the preload spring 18.

In some embodiments, the inner race member 15 includes a pocket 30 located between the inner bore 25 and the piloting extension 28. The pocket 30 is configured to receive the passive preload ring 19. In some embodiments, the pocket 30 and the raceway 27 are radially aligned about the inner bore 25.

During operation of the CVP 10, the passive preload ring 19 thermally expands within the pocket 30 to provide a thermally sensitive axial force between the cam driver 13 and the inner race member 15.

In some embodiments, the passive preload ring 19 is made of a material having a larger thermal expansion coefficient than the surround material. For example, the passive preload ring 19 is composed of a polymer material. It should be appreciated that a designer sets the dimensions and the material of the passive preload ring 19 based on the axial force desired or needed during operation of the CVP, which takes into account the size of the CVP and the duty cycle or anticipated operating requirements of the CVP, among other considerations.

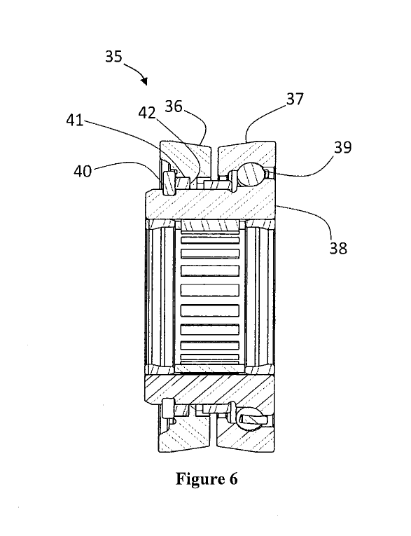

Referring now to FIG. 6, in some embodiments an idler assembly 35 is included in the variator depicted in FIGS. 1-3 or the CVP 10. In some embodiments, the idler assembly 35 includes a first idler ring 36 and a second idler ring 37 adapted to contact the balls 1. In some embodiments, the idler assembly 35 includes an idler race 38 configured to support an idler bearing 39. In some embodiments, the idler bearing 39 is coupled to the second idler ring 37.

In some embodiments, the first idler ring 36 is coupled to the idler race 38 with a retaining clip 40. The retaining clip 40 is configured to axially retain the first idler ring 36 with respect to the idler race 38.

In some embodiments, the idler assembly 35 includes a passive preload ring 41 positioned between the idler race 38 and the first idler ring 36. In some embodiments, the passive preload ring 41 is constrained axially by the retaining clip 40 and a reaction face 42 formed on the first idler ring 36. The reaction face 42 is formed on the inner bore of the first idler ring 36.

In some embodiments, the passive preload ring 41 is made of a material having a larger thermal expansion coefficient than the surround material. For example, the passive preload ring 41 is composed of a polymer material. During operation, the passive preload ring 41 expands as temperature increases to thereby increase the axial force applied to traction surfaces on the first idler ring 36 and the second idler ring 37. It should be appreciated that a designer sets the dimensions and the material of the passive preload ring 41 based on the axial force desired or needed during operation of the CVP, which takes into account the size of the CVP and the duty cycle or anticipated operating requirements of the CVP, among other considerations.

The foregoing description details certain embodiments. It will be appreciated, however, that no matter how detailed the foregoing appears in text, the preferred embodiments can be practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A continuously variable transmission (CVT) having a plurality of balls, each ball having a tiltable axis of rotation, each ball in contact with a first traction ring and a second traction ring, the CVT comprising:
a main shaft aligned along a longitudinal axis of the CVT, the main shaft positioned radially inward of the balls, the first traction ring and the second traction ring;
a cam driver operably coupled to the first traction ring;
an axial thrust bearing operably coupled to the cam driver and the main shaft;
an inner race member coupled to the axial thrust bearing and the cam driver;
an outer race member coupled to the axial thrust bearing and the main shaft; and
a passive preload ring coupled to the inner race member and the cam driver.

2. The CVT of claim 1, wherein the inner race member is an annular ring having an inner bore and an outer periphery, and wherein the passive preload ring is located between the inner bore and the outer periphery.

3. The CVP of claim 2, wherein the inner race member further comprises a raceway located between the inner bore and the outer periphery, the raceway configured to receive the axial thrust bearing.

4. The CVP of claim 1, wherein the passive preload ring has a larger thermal coefficient of expansion than the inner race member.

5. A passive preload device for a ball-type continuously variable planetary, the passive preload device comprising:
an axial thrust bearing;
an inner race member coupled to the axial thrust bearing;
a passive preload ring coupled to the inner race member;
an outer race member coupled to the axial thrust bearing; and
wherein the passive preload ring has a larger thermal expansion coefficient than the inner race member.

6. The passive preload device of claim 5, wherein the passive preload ring comprised of a polymer material.

7. An idler assembly for a ball-type continuously variable planetary, the passive preload device comprising:
a first idler ring;
a second idler ring;
an idler race coupled to the first idler ring, the idler race positioned radially inward of the first idler ring and the second, idler ring;
an idler bearing coupled to the second idler ring and the idler race;
a retaining clip coupled to the idler race and the first idler ring;
a passive preload ring coupled to the retaining clip and the first idler ring; and
wherein the passive preload ring has a larger thermal expansion coefficient than the first idler ring.

8. The idler assembly of claim 7, wherein the passive preload ring is comprised of a polymer material.
